(19) United States
(12) Patent Application Publication
(10) Pub. No.: US 2006/0244980 A1
(43) Pub. Date: Nov. 2, 2006

(54) Image quality adjustment method and system

(75) Inventor: Robert E. Grace, Fairport, NY (US)

Correspondence Address: John S. Zanghi, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/115,766

(22) Filed: Apr. 27, 2005

(51) Int. Cl. G06K 9/40

(52) U.S. Cl. 358/1.9; 382/254; 358/504

(57) ABSTRACT

An image rendering system periodically prints test patches on a duplex sheet from a plurality of marking engines, using a simple emitter-detector pair as a feedback means in image quality control. Image lightness is controlled by analyzing the test patches to determine updated marking engine actuator set points. For instance, ROS exposure and/or scorotron grid voltages are adjusted to maintain image lightness consistency between marking engines.

### CROSS-REFERENCE TO RELATED APPLICATIONS

The following applications, the disclosures of each being totally incorporated herein by reference are mentioned:

U.S. Provisional Application Ser. No. 60/631,651 (Attorney Docket No. 20031830-US-PSP), filed Nov. 30, 2004, entitled “TIGHTLY INTEGRATED PARALLEL PRINTING ARCHITECTURE MAKING USE OF COMBINED COLOR AND MONOCHROME ENGINES,” by David G. Anderson, et al.;

U.S. Provisional Patent Application Ser. No. 60/631,918 (Attorney Docket No. 20031867-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. Patent Provisional Patent Application Ser. No. 60/631,921 (Attorney Docket No. 20031867Q-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. patent application Ser. No. 10/761,522 (Attorney Docket A2423-US-NP), filed Jan. 21, 2004, entitled “HIGH RATE PRINT MERGING AND FINISHING SYSTEM FOR PARALLEL PRINTING,” by Barry P. Mandel, et al.;

U.S. patent application Ser. No. 10/785,211 (Attorney Docket A3249P1-US-NP), filed Feb. 24, 2004, entitled “UNIVERSAL FLEXIBLE PLURAL PRINTER TO PLURAL FINISHER SHEET INTEGRATION SYSTEM,” by Robert M. Lofthus, et al.;

U.S. patent application Ser. No. 10/860,195 (Attorney Docket A3249Q-US-NP), filed Aug. 23, 2004, entitled “UNIVERSAL FLEXIBLE PLURAL PRINTER TO PLURAL FINISHER SHEET INTEGRATION SYSTEM,” by Robert M. Lofthus, et al.;

U.S. patent application Ser. No. 10/881,619 (Attorney Docket A0723-US-NP), filed Jun. 30, 2004, entitled “FLEXIBLE PAPER PATH USING MULTIDIRECTIONAL PATH MODULES,” by Daniel G. Bobrow.; U.S. patent application Ser. No. 10/917,676 (Attorney Docket A3404-US-NP), filed Aug. 13, 2004, entitled “MULTIPLE OBJECT SOURCES CONTROLLED AND/OR SELECTED BASED ON A COMMON SENSOR,” by Robert M. Lofthus, et al.;

U.S. patent application Ser. No. 10/917,768 (Attorney Docket 20040184-US-NP), filed Aug. 13, 2004, entitled “PARALLEL PRINTING ARCHITECTURE CONSISTING OF CONTAINERIZED IMAGE MARKING ENGINES AND MEDIA FEEDER MODULES,” by Robert M. Lofthus, et al.;

U.S. patent application Ser. No. 10/924,106 (Attorney DocketA4050-US-NP), filed Aug. 23, 2004, entitled “PRINTING SYSTEM WITH HORIZONTAL HIGHWAY AND SINGLE PASS DUPLEX,” by Lofthus, et al.;

U.S. patent application Ser. No. 10/924,113 (Attorney Docket A3190-US-NP), filed Aug. 23, 2004, entitled “PRINTING SYSTEM WITH INVERTER DISPOSED FOR MEDIA VELOCITY BUFFERING AND REGISTRATION,” by Joannes N. M. dejong, et al.;

U.S. patent application Ser. No. 10/924,458 (Attorney Docket A3548-US-NP), filed Aug. 23, 2004, entitled “PRINT SEQUENCE SCHEDULING FOR RELIABILITY,” by Robert M. Lofthus, et al.;

U.S. patent application Ser. No. 10/924,459 (Attorney Docket No. A3419-US-NP), filed Aug. 23, 2004, entitled “PARALLEL PRINTING ARCHITECTURE USING IMAGE MARKING ENGINE MODULES (as amended),” by Barry P. Mandel, et al;

U.S. patent application Ser. No. 10/933,556 (Attorney Docket No. A3405-US-NP), filed Sep. 3, 2004, entitled “SUBSTRATE INVERTER SYSTEMS AND METHODS,” by Stan A. Spencer, et al.;

U.S. patent application Ser. No. 10/953,953 (Attorney Docket No. A3546-US-NP), filed Sep. 29, 2004, entitled “CUSTOMIZED SET POINT CONTROL FOR OUTPUT STABILITY IN A TIPP ARCHITECTURE,” by Charles A. Radulski et al.;

U.S. patent application Ser. No. 10/999,326 (Attorney Docket 20040314-US-NP), filed Nov. 30, 2004, entitled “SEMI-AUTOMATIC IMAGE QUALITY ADJUSTMENT FOR MULTIPLE MARKING ENGINE SYSTEMS,” by Robert E. Grace, et al.;

U.S. patent application Ser. No. 10/999,450 (Attorney Docket No. 20040985-US-NP), filed Nov. 30, 2004, entitled “ADDRESSABLE FUSING FOR AN INTEGRATED PRINTING SYSTEM,” by Robert M. Lofthus, et al.;

U.S. patent application Ser. No. 11/000,158 (Attorney Docket No. 20040503-US-NP), filed Nov. 30, 2004, entitled “GLOSSING SYSTEM FOR USE IN A TIPP ARCHITECTURE,” by Bryan J. Roof;

U.S. patent application Ser. No. 11/000,168 (Attorney Docket No. 20021985-US-NP), filed Nov. 30, 2004, entitled “ADDRESSABLE FUSING AND HEATING METHODS AND APPARATUS,” by David K. Biegelsen, et al.;

U.S. patent application Ser. No. 11/000,258 (Attorney Docket No. 20040503Q-US-NP), filed Nov. 30, 2004, entitled “GLOSSING SYSTEM FOR USE IN A TIPP ARCHITECTURE,” by Bryan J. Roof;

U.S. patent application Ser. No. 11/001,890 (Attorney Docket A2423-US-DIV), filed Dec. 2, 2004, entitled “HIGH RATE PRINT MERGING AND FINISHING SYSTEM FOR PARALLEL PRINTING,” by Robert M. Lofthus, et al.;

U.S. patent application Ser. No. 11/002,528 (Attorney Docket A2423-US-DIV1), filed Dec. 2, 2004, entitled “HIGH RATE PRINT MERGING AND FINISHING SYSTEM FOR PARALLEL PRINTING,” by Robert M. Lofthus, et al.;

U.S. patent application Ser. No. 11/051,817 (Attorney Docket 20040447-US-NP), filed Feb. 4, 2005, entitled “PRINTING SYSTEMS,” by Steven R. Moore, et al.;

U.S. patent application Ser. No. 11/069,020 (Attorney Docket 20040744-US-NP), filed Feb. 28, 2005, entitled “PRINTING SYSTEMS,” by Robert M. Lofthus, et al.;

U.S. patent application Ser. No. 11/070,681 (Attorney Docket 20031659-US-NP), filed Mar. 2, 2005, entitled “GRAY BALANCE FOR A PRINTING SYSTEM OF MULTIPLE MARKING ENGINES,” by R. Enrique Viturro, et al.;

U.S. patent application Ser. No. 11/081,473 (Attorney Docket 20040448-US-NP), filed Mar. 16, 2005, entitled “MULTI-PURPOSE MEDIA TRANSPORT HAVING INTEGRAL IMAGE QUALITY SENSING CAPABILITY,” by Steven R. Moore;

U.S. patent application Ser. No. ______ (Attorney Docket 20040974-US-NP), filed Mar. 18, 2005, entitled “SYSTEMS AND METHODS FOR MEASURING UNIFORMITY IN IMAGES,” by Howard Mizes;

U.S. patent application Ser. No. ______ (Attorney Docket 20040241-US-NP), filed Mar. 25, 2005, entitled “SHEET REGISTRATION WITHIN A MEDIA INVERTER,” by Robert A. Clark et al.;

U.S. patent application Ser. No. ______ (Attorney Docket 20040619-US-NP), filed Mar. 25, 2005, entitled “INVERTER WITH RETURN/BYPASS PAPER PATH,” by Robert A. Clark;

U.S. patent application Ser. No. ______ (Attorney Docket 20031468-US-NP), filed Mar. 25, 2005, entitled IMAGE QUALITY CONTROL METHOD AND APPARATUS FOR MULTIPLE MARKING ENGINE SYSTEMS,” by Michael C. Mongeon;

U.S. application Ser. No. ______ (Attorney Docket 20040677-US-NP), filed Mar. 29, 2005, entitled “PRINTING SYSTEM,” by Paul C. Julien;

U.S. patent application Ser. No. ______ (Attorney Docket 20040676-US-NP), filed Mar. 31, 2005, entitled “PRINTING SYSTEM,” by Paul C. Julien;

U.S. patent application Ser. No. ______ (Attorney Docket 20040971-US-NP), filed Mar. 31, 2005, entitled “PRINTING SYSTEM,” by Jeremy C. dejong, et al.;

U.S. patent application Ser. No. ______ (Attorney Docket 20040446-US-NP), filed Mar. 31, 2005, entitled “IMAGE ON PAPER REGISTRATION ALIGNMENT,” by Steven R. Moore, et al.;

U.S. patent application Ser. No. ______ (Attorney Docket 20031520-US-NP), filed Mar. 31, 2005, entitled “PARALLEL PRINTING ARCHITECTURE WITH PARALLEL HORIZONTAL PRINTING MODULES,” by Steven R. Moore, et al.;

U.S. patent application Ser. No. ______ (Attorney Docket 20041209-US-NP), filed Apr. 8, 2005, entitled “SYNCHRONIZATION IN A DISTRIBUTED SYSTEM,” by Lara S. Crawford, et al.;

U.S. patent application Ser. No. ______ (Attorney Docket 20041210-US-NP), filed Apr. 8, 2005, entitled “COORDINATION IN A DISTRIBUTED SYSTEM,” by Lara S. Crawford, et al.;

U.S. patent application Ser. No. ______ (Attorney Docket 20041213-US-NP), filed Apr. 8, 2005, entitled “COMMUNICATION IN A DISTRIBUTED SYSTEM,” by Markus P. J. Fromherz, et al.; and

U.S. patent application Ser. No. ______ (Attorney Docket 20041214-US-NP), filed April 8, entitled “ON-THE-FLY STATE SYNCHRONIZATION IN A DISTRIBUTED SYSTEM,” by Haitham A. Hindi.

### BACKGROUND

Illustrated herein are methods and systems for adjusting image quality or image consistency in multiple printing or marking engine systems. Embodiments will be described in detail with reference to electrophotographic or xerographic print engines. However, it is to be appreciated that embodiments associated with other marking or rendering technologies are contemplated.

Generally, the output of any system should match some target or desired output. For instance, in image rendering or printing systems it is desirable for a printed image to closely match, or have similar aspects or characteristics to, a desired target or input image. However, many factors, including temperature, humidity, ink or toner age, and/or component wear, tend to move the output of a rendering or printing system away from the ideal or target output. In xerographic marking engines, for example, component tolerances and drifts as well as environmental disturbances may tend to move an engine response curve (ERC) away from an ideal, desired or target engine response and toward an engine response that yields images that are lighter or darker than desired.

To combat these tendencies, rendering systems or marking engines are designed with closed loop controls that operate to drive the engine response curve of a marking engine back toward the ideal or target response. Optical sensors may be used to sense the reflectance of multiple intra-image or intra-document half-tone test patches. The resulting reflectance values are compared to stored reference or target values. Error values, resulting from these comparisons are used to adjust xerographic process actuators. This process is repeated until the errors are minimized, and performed on an ongoing basis in order to prevent or limit engine response curve variation.

Additional control loops may also be employed. For instance, an electrostatic voltmeter (ESV) may be used to measure a charge (or a voltage associated with the charge) placed on a photoconductive belt or drum. The level of charge placed on the photoconductor is a factor in the amount of toner attracted to the photoconductor during a development process. A xerographic actuator, such as a corotron or scorotron wire voltage or a scorotron grid voltage, is controlled so that a measurement received from the ESV is driven toward a voltage target or set point. The set point may be changed to darken or lighten an image.

Toner concentration (TC) sensors can sense magnetic reluctance associated with magnetic carrier particles, or a developer mixture, in a developer housing. When the toner concentration is high, the average spacing between the magnetic carrier beads is greater and the reluctance signal is lower. As the TC sensor magnetic reluctance signal changes, from a toner concentration/magnetic reluctance set point, the rate at which fresh toner is dispensed into the developer housing is changed. The amount of toner transferred to the photoconductor can be a function of the toner concentration in the developer housing. The toner concentration/magnetic reluctance set point may be adjusted to lighten ordarken an engine response curve or drive an engine response curve toward an ideal ordesired position.

While these methods may be effective in stabilizing and/or controlling engine response curves, they employ sensors and associated controls that add cost to the systems and may have substantial physical space requirements. It is generally desirable to reduce both the cost and size of marking engines. Therefore, there is a need for systems and methods that maintain image quality, while eliminating the need for some or all of these expensive sensors and associated control loops.

Some marking engine designs use feed-forward adjustment of process actuators based on lookup tables instead of run time density control. For example, temperature, relative humidity, print count, paper size and other parameters are used to generate and index into one or more lookup tables. The lookup tables provide set points for one or more xerographic actuators. Such systems generally provide effective engine response curve stabilization. However, over time, due to system wear and other sources of drift, the set points stored in the tables can become outdated or inappropriate. Such systems would benefit from a simple and inexpensive means for recalibration, trimming or fine tuning.

Additionally, in order to provide increased production speed, document processing systems that include a plurality of marking engines have been developed. In such systems, the importance of engine response control or stabilization is amplified. Subtle changes that would go unnoticed in the output of a single marking engine can be highlighted in the output of a multi-engine image rendering or marking system. For example, the facing pages of an opened booklet rendered or printed by a multi-engine printing system can be rendered by different devices. The left hand page in an open booklet may be rendered by a first print engine while the right-hand page is rendered by a second print engine. The first print engine may be rendering images in a manner just slightly darker than the ideal and well within a single engine tolerance. The second print engine may be rendering images in a manner just slightly lighter than the ideal and also within the single engine tolerance. While an observer might not ever notice the subtle variations when reviewing the output of either engine alone, when their output is compiled and displayed in the facing pages of a booklet the variation may become noticeable and be perceived by a printing services' customer as an issue of quality.

There are patents relating to improving image consistency in a print engine and these are also hereby incorporated herein by reference for all they disclose. For example, U.S. Pat. No. 4,710,785, which issued Dec. 1, 1987 to Mills, entitled PROCESS CONTROL FOR ELECTROSTATIC MACHINE, discusses an electrostatic machine having at least one adjustable process control parameter. U.S. Pat. No. 5,510,896, which issued Apr. 23, 1996 to Wafler, entitled AUTOMATIC COPY QUALITY CORRECTION AND CALIBRATION, discloses a digital copier that includes an automatic copy quality correction and calibration method that corrects a first component of the copier using a known test original before attempting to correct other components that may be affected by the first component. U.S. Pat. No. 5,884,118, which issued Mar. 16, 1999 to Mestha, entitled PRINTER HAVING PRINT OUTPUT LINKED TO SCANNER INPUT FOR AUTOMATIC IMAGE ADJUSTMENT, discloses an imaging machine having operating components including an input scanner for providing images on copy sheets and a copy sheet path connected to the input scanner. U.S. Pat. No. 6,418,281, which issued Jul. 9, 2002 to Ohki, entitled IMAGE PROCESSING APPARATUS HAVING CALIBRATION FOR IMAGE EXPOSURE OUTPUT, discusses a method wherein a calibration operation is performed in which a predetermined grayscale pattern is formed on a recording paper and this pattern is read by a reading device to produce a LUT for controlling the laser output in accordance with the image signal (gamma correction).

These patents, however, are not concerned with systems and methods for improving or achieving image consistency between or among a plurality of marking engines. In this regard, U.S. patent application Ser. No. 10/999,326 (Attorney Docket 20040314-US-NP), filed Nov. 30, 2004, entitled “SEMI-AUTOMATIC IMAGE QUALITY ADJUSTMENT FOR MULTIPLE MARKING ENGINE SYSTEMS,” by Robert E. Grace, et al., relates to a system and method for equalizing image quality among multiple monochrome marking engines. A test print from each engine is transported to a scanner for measurement. The image quality adjustment is based on an accurate measurement of half-tone gray level on a print from each marking engine, and, in effect, calibrating each engine to an absolute standard. While this calibration is indeed desirable, another important metric in multi-engine systems is the relative calibration among marking engines. Considerable drift in TRC (tone reproduction curve) performance is acceptable, so long as all of the engines drift together.

For the foregoing reasons, there is a desire for a method and system for calibrating, trimming, adjusting or fine tuning marking engine controls or set points, while eliminating or reducing the need for, or accuracy requirements of, at least some internal marking engine sensors.

### BRIEF DESCRIPTION

Aspects of the present disclosure in embodiments thereof include methods and systems for image quality control in image rendering systems. In one embodiment, a first test image is printed on one side of print media with a first marking engine in an image rendering system, a second test image is printed on the other side of the print media with a second marking engine in the image rendering system, image consistency information from the test images is determined, and, if necessary, at least one aspect of the image rendering system is adjusted, in a manner predetermined to improve image consistency, based on the determined image consistency information.

In another embodiment, an image quality control method fora xerographic print system having a plurality of marking engines comprises printing a first test image on one side of print media with a first marking engine, printing a second test image on the opposite side of the print media with a second marking engine, determining image consistency information from the test images, and, if necessary, adjusting at least one aspect of the xerographic print system, in a manner predetermined to improve image consistency, based on the determined image consistency information.

An embodiment of the image quality control system includes a plurality of xerographic print engines, each xerographic print engine having at least one xerographic actuator, a test patch generator operative to control each of the plurality of xerographic print engines to generate a mid-tone test patch on both sides of a sheet, an emitter positioned to emit light through the sheet, a detector positioned to detect the light emitted by the emitter, a test patch analyzer operative to analyze a plurality of test patches generated by the plurality of xerographic print engines and operative to determine an amount at least one of the xerographic actuators should be adjusted based on the analysis, and a xerographic actuator adjuster operative to adjust the at least one xerographic actuator according to the amount determined by the test patch analyzer.

### BRIEF DESCRIPTION OF THE DRAWINGS

FIG. 1 is an elevation view of a first image or document processing system including a plurality of marking engines.

FIG. 2 is a block diagram of a second image or document processing system including a plurality of marking engines including elements adapted to carry out the method of FIG. 3.

FIG. 3 is a flow chart outlining an image quality adjustment method.

FIG. 4 is a block diagram showing test image content on the front side of a sheet.

FIG. 5 is a block diagram showing test image content on both sides of the sheet when viewed in transmission.

FIG. 6 shows a transmission sensor consisting of an emitter-detector pair.

FIG. 7 is a flow chart outlining a method for analyzing imaged test prints and determining new settings based on the analysis.

FIG. 8 is a flow chart outlining an alternative method for analyzing imaged test prints and determining new settings based on the analysis.

### DETAILED DESCRIPTION

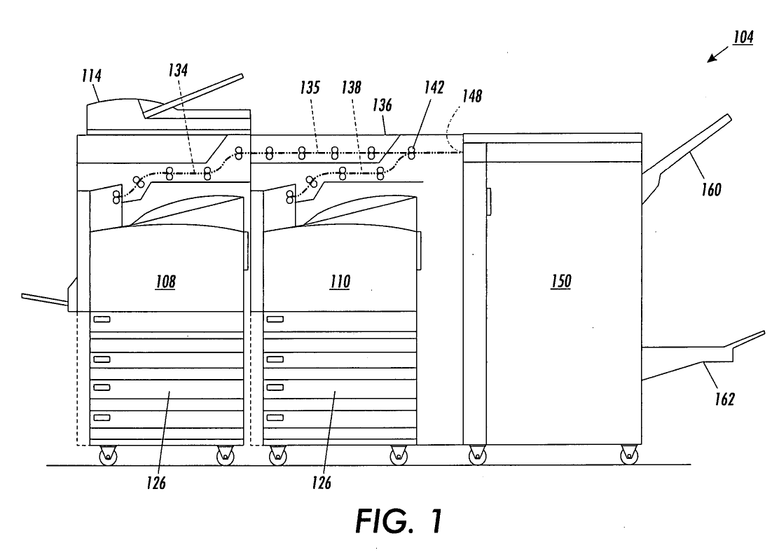

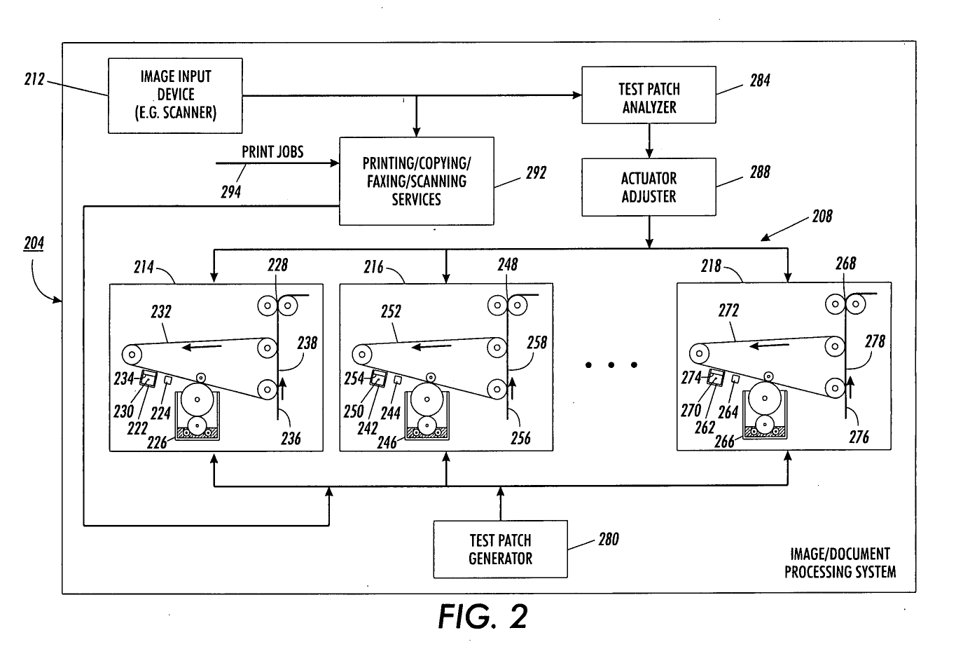

FIG. 1 illustrates a first image (or document) rendering (or processing) system 104 suitable for incorporating embodiments of the methods and systems disclosed herein. The first image rendering system 104 includes a first image output terminal (IOT) 108, a second image output terminal 110 and an image input device 114, such as a scanner, imaging camera or other device. Each image output terminal 108, 110 includes a plurality of input media trays 126 and an integrated marking engine (e.g., see FIG. 2 and related description below). The first IOT 108 may support the image input device 114 and includes a first portion 134 of a first output path. A second portion 135 of the first output path is provided by a bypass module 136. The second IOT 110 includes a first portion 138 of a second output path. A third portion of the first path and a second portion of the second path begin at a final nip 142 of the second IOT 110 and include an input to a finisher 150.

The finisher 150 includes first 160 and second 162 main job output trays. Depending on a document processing job description and on the capabilities of the finisher 150, one or both of the main job output trays 160, 162 may collect loose pages or sheets, stapled or otherwise bound booklets, shrink wrapped assemblies or otherwise finished documents. The finisher 150 receives sheets or pages from one or both of the image output terminals 108, 110 via the input 148 and processes the pages according to a job description associated with the pages or sheets and according to the capabilities of the finisher 150.

A controller (not shown) orchestrates the production of printed or rendered pages, their transportation over the various path elements (e.g., 134, 135, 138, 142 and 148), and their collation and assembly as job output by the finisher 150. Rendered (or printed) pages or sheets may include images received via facsimile, transferred to the document processing system from a word processing, spreadsheet, presentation, photo editing or other image generating software, transferred to the document processor 104 over a computer network or on a computer media, such as, a CD ROM, memory card or floppy disc, or may include images generated by the image input device 114 of scanned or photographed pages or objects. Additionally, on an occasional, periodic, or as needed or requested basis, the controller (not shown) may orchestrate the generation, printing or rendering of test, diagnostic or calibration sheets or pages. As will be explained in greater detail below, such test, diagnostic or calibration sheets may be transferred to the image input device 114, which can be used to generate computer readable representations of the rendered test images. The computer readable representations may then be analyzed by the controller, or some auxiliary device, to determine image consistency information, and, if necessary, adjust some aspect of the image rendering system in a manner predetermined or known to make an improvement in, or achieve, image consistency. In this regard, electrophotographic, xerographic, or other rendering technology actuators may be adjusted. Alternatively, image path data may, be manipulated to compensate or correct for some aspect of the rendering or marking process based on the analysis of the computer readable representations of the test images.

FIG. 2 shows a second image or document processing system 204 includes a plurality 208 of print or marking engines and an image input device 212. The plurality 208 of marking engines includes a first 214, second 216, and n^{th} 218 xerographic marking engines. For simplicity, the xerographic marking engines 214, 216, 218 are illustrated as monochrome marking engines. However, embodiments including color marking engines as well as marking engines of other technologies are also contemplated.

Each marking technology is associated with marking technology actuators. Thus, the first xerographic marking engine 218 includes a charging element 222, a writing element 224, a developer 226 and a fuser 228. Each of these can be associated with one or more xerographic actuators.

The charging element 222 may be a corotron, a scorotron, or a dicorotron. In each of these devices a voltage is applied to a coronode (wire or pins) 230. The voltage on the coronode 230 ionizes surrounding air molecules, which, in turn, cause a charge to be applied to a photoconductive belt 232 or drum. Where the charging element 222 is a scorotron, the scorotron includes a grid 234. A grid voltage is applied to the grid 234. The scorotron grid is located between the coronode 230 and the photoconductor 232 and helps control the charge strength and the charge uniformity of the charge applied to the photoconductor 232. The coronode voltage and the grid voltage are xerographic actuators. Changing either voltage may result in a change in the charge applied to the photoconductor 232, which, in turn, may affect the amount of toner attracted to the photoconductor 232 and, therefore, the lightness or darkness of a printed or rendered image. Many xerographic marking engines include at least one electrostatic voltmeter (ESV) for measuring the charge applied to the photoconductor 232. A control loop receives information from the ESV and adjusts one or both of the coronode voltage and the grid voltage in order to maintain a desired ESV measurement. However, the methods and systems disclosed herein reduce or eliminate the need for these ESV-based control loops, and the marking engines 214, 216, and 218 of the second image or document processor 204 do not include ESVs.

The writing element 224 is typically a raster output scanner. A raster output scanner (ROS) includes a laser, and a polygonal arrangement of mirrors, which is driven by a motor to rotate. A beam of light from the laser is aimed at the mirrors. As the arrangement of mirrors rotates a reflected beam scans across a surface of the photoconductor 232. The beam is modulated on and off. As a result, portions of the photoconductor 232 are discharged. Alternatively, the ROS may include one or more light emitting diodes (LEDs). An array of LEDs may be positioned over respective portions of the photoconductor 232. Lighting an LED tends to discharge the photoconductor at positions associated with the lit LED. ROS exposure is a xerographic actuator. The exposure, or amount of light that reaches the photoconductor 232, is a function of ROS power and/or ROS exposure time. The higher the laser or LED power, the more discharged associated portions of the photoconductor 232 become. Alternatively, the longer a particular portion of the photoconductor 232 is exposed to laser or LED light, the more discharged the portion becomes. The degree to which portions of the photoconductor 232 are charged or discharged affects the amount of toner that is attracted to the photoconductor 232. Therefore, adjusting ROS exposure adjusts the lightness of a rendered or printed image.

The developer 226 includes a reservoir of toner. The concentration of toner in the reservoir has an effect on the amount of toner attracted to charge portions of the photoconductor 232. For instance, the higher the concentration of toner in the reservoir, the more toner is attracted to portions of the photoconductor 232. Therefore, toner concentration in the reservoir is a xerographic actuator. Toner concentration can be controlled by controlling the rate at which toner from a toner supply is delivered to the developer toner reservoir.

Many xerographic marking engines include an optical density sensor for measuring the density of toner applied to the photoconductor 232. Test images or patches may be developed on interdocument zones on the photoconductor 232. The optical density sensor measures the density of toner applied in the test patches and xerographic actuators are adjusted if the optical density sensors report that the toner density in the test patch is different from a target density. However, the systems and methods disclosed herein reduce or eliminate the need for optical density sensor measurements, and the marking engines 214, 216, 218 of the second image or document processing system 204 do not include optical density sensors.

Print media is transported on a media transport 236. In embodiments, print media refers, for example, to sheets of paper or velum. Toner on the photoconductor 232 is transferred to the media at a transfer point 238. The print media is transported to the fuser 228 where elevated temperatures and pressures operate to fuse the toner to the print media. Pressures and temperatures of the fuser 228 are xerographic actuators.

Other xerographic actuators are known. Additionally, other printing technologies include actuators that can be adjusted to control the lightness or darkness of a printed or rendered image. For example, in ink jet marking engines, a drop ejection voltage controls an amount of ink propelled toward print media with each writing pulse. Therefore, drop ejection voltage is an ink jet actuator.

Other xerographic print engines in the second document or imaging processing system 204 include similar elements. Thus, the second xerographic marking engine 216 also includes a charging element 242, a writing element 244, a developer 246, a fuser 248, a coronode 250 and a photoconductor 252. The charging element may include a charging grid 254. A media transport 256 carries print media to a transfer point 258 and to the fuser 248. Likewise, the n^{th} xerographic print engine 218 includes α-charging element 262, a writing element 264, a developer 266 and a fuser 268. The charging element 262 may include a coronode 270 for ionizing molecules to charge a photoconductor 272. If the charging element 262 is, for example, a scorotron, the charging element 262 may include a grid 274. The n^{th} xerographic marking engine 218 may also include, or be associated with a media transport 276, for carrying print media to a transfer point 278, to the fuser 268 and beyond (i.e., to a finisher or output tray).

The second document or image processing system 204 also includes a test patch generator 280, a test patch analyzer 284 and an actuator adjuster 288. The system 204 may also include one or more of printing, copying, faxing and scanning services 292. The test patch generator 280, test patch analyzer 284 and actuator adjuster 288 are generally embodied in software run by a controller (not shown). Alternatively, one or more of the test patch generator 280, test patch analyzer 284, and actuator adjuster 288 may be implemented in hardware supervised by the controller (not shown).

The test patch generator 280, test patch analyzer 284, actuator adjuster 288, and two or more of the plurality 208 of print or marking engines, cooperate to perform one or more methods that are operative to control image consistency.

For instance, the test patch generator 280 is operative to control each of the plurality of xerographic print engines to generate a printed version of a mid-tone test patch. The test patch analyzer 284 is operative to analyze the test patches generated by the image input device 212. Additionally, the test patch analyzer is operative to determine an amount at least one xerographic actuator should be adjusted based on the analysis. The actuator adjuster 288 is operative to adjust the at least one xerographic actuator according to the amount determined by the test patch analyzer 284. The test patch generator 280, test patch analyzer 284, and actuator adjuster 288 are included as a means for controlling or adjusting image quality in main print job production.

A function of the image input device 212 is to generate computer readable representations or versions of imaged items, such as, a printed sheet or a collection of printed sheets, so that copies of the imaged item or items can be printed or rendered by one or more of the plurality 208 of marking engines. In addition to these copying services 292, the document or image processing system 264 may provide printing, faxing and/or scanning services 292. Thus, print job descriptions 294 may be received by the image or document processing system 204 over a computer network or on computer readable media. Additionally, print jobs 294 may include incoming or received facsimile transmissions. The printing, copying, faxing, scanning services 292 of the image or document processing system 204 control one or more of the first 214, second 216, and/or n^{th} 218 printing or marking engines to produce the received print jobs 294.

As will be described in greater detail below, the test patch generator 280, the test patch analyzer 284 and the actuator adjuster 288 operate to control or adjust the plurality 208 of marking engines so that portions of such print jobs printed on a first marking engine (e.g., 214) appear the same as portions printed or rendered using a second print engine (e.g., 216 or 218).

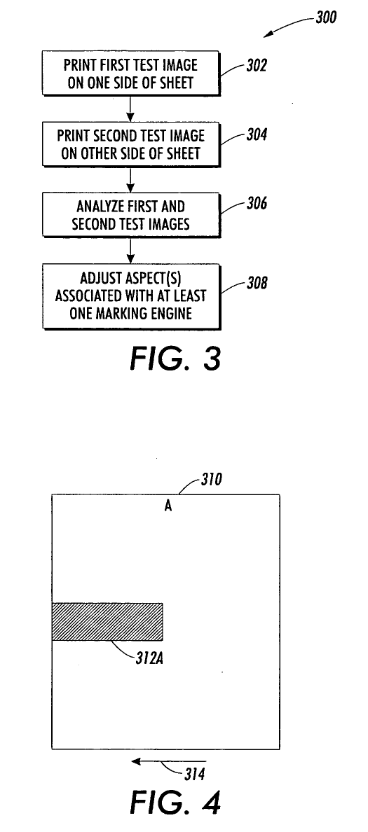

Relative mid-tone TRC performance between at least two marking engines can be measured accurately and at very low cost by printing a duplex print in which one side is printed on the first print engine and the second side is printed on another print engine. FIG. 3 illustrates a method 300 for controlling image consistency in image rendering systems, such as the systems 104, 204 illustrated in FIGS. 1 and 2, respectively. The method 300 includes printing 302 a first test patch or image on one side of a sheet with a first marking engine, printing 304 a second test patch or image on the other side of the sheet with a second marking engine, analyzing 306 the first and second test images, and adjusting 308 at least one aspect associated with at least one of the first and second marking engines in a manner predetermined to improve engine to engine consistency.

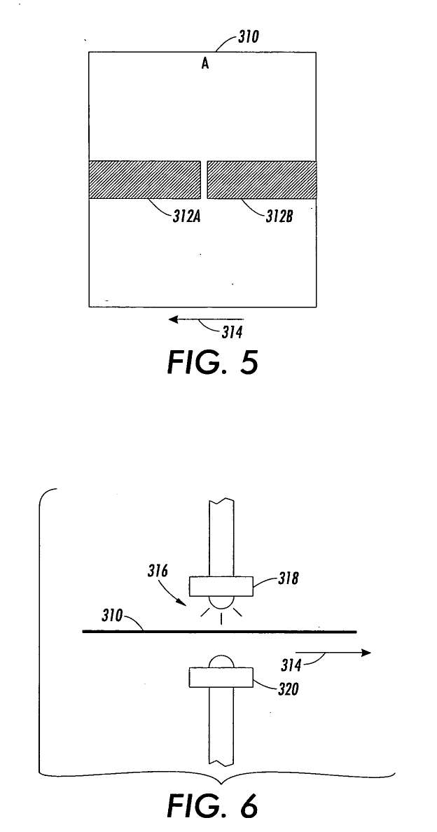

Referring now to FIGS. 4 and 5, in embodiments, the test patch or image content on side A of the sheet 310, for example, consists of a first mid-level half-tone stripe (50% Cin, for example) 312A across approximately half of the sheet 310 in the process direction, represented by the arrow 314. In embodiments, the test image content on the other side of the sheet, for example, consists of a second mid-level half-tone stripe 310B across approximately half of the sheet 310. Either side of the sheet 310, when viewed by reflection, would appear as shown in FIG. 4, but when printed on both sides of the sheet 310 and viewed in transmission, the sheet 310 would appear as shown in FIG. 5.

The test image may include any test image appropriate for the aspect of printing or marking to be analyzed and controlled or compensated for. For example, Monte Carlo simulations of 1000 marking engines of a particular type, with randomized developer and xerographic replaceable unit (XRU) (including the photoconductor, charging element and a cleaning blade) age, indicate that variation in marking engine response curves (over time and from marking engine to marking engine), related to the overall lightness or darkness of rendered images, can be controlled or compensated for by analyzing 306 mid-tone test patches rendered or printed 302, 304 by the marking engines. Mid-tone test patches include test patches intended to have half-tone unit cell area coverage of about 30% to about 70%. Test patch selection 314 may be based on a desire to study, analyze, correct or compensate for a particular portion of the engine response curve of one or more engines. However, the simulations indicate that good engine response stabilization can be achieved by periodically printing 302, 304, analyzing 306 and adjusting 308, based on the analysis of a test patch for each engine intended to have area coverage of about 50%.

Test image selection may occur during system design or manufacture. For instance, a single test image or a set of selectable test images may be represented in digital form and stored in system memory. Additionally, or alternatively, a system user may periodically, or on an as needed or desired basis, select a particular compensation or adjustment mode, and thereby select an appropriate test image from a plurality of test images stored in the system. Additionally, test images may be provided in the form of standard test image prints, which are scanned or otherwise imaged and represented in computer readable form through the use of a main image input device (e.g., 114, 212).

Printing 302, 304 the test image proceeds as would the printing or rendering of images from any other print job. For example, printing the first test image includes using the charging element 222 to place a charge on the photoconductor 232. The photoconductor 232 moves. The writing element 224 is used to expose selected portions of the photoconductor 232 to light. The exposed portions are discharged according to the level of exposure. The portions selected to be exposed are based on an analysis of the test images 312A, 312B. The charged and uncharged portions are transported to the developer 226. Depending on the system and toner type, toner is attracted to charged or discharged portions of the photoconductor 232. The photoconductor 232 continues to move and the developed image is brought to the transfer point 238 and brought into contact with print media, such as a sheet of paper or velum, while an electrostatic field is applied. The print media is then transported to the fuser 228 where the toner is fused to the print media. The printed sheet is then transported to an output tray (e.g., 160, 162).

Printing 322 or generating the second test image 312B on the sheet 310 proceeds in a similar manner but on a second or different marking engine, such as, for example, the second marking engine 216 or any other of the plurality of marking engines 208, including, for example, the n^{th} marking engine 218. Generally, printing 322 the second test image 312B with the second marking engine 216 would involve using the charging element 242, the writing element, the developer 246, the photoconductor 255, the transfer point 258 and the fuser 248 of the second 216 marking engine. Using the n^{th} marking engine 218 to print 322 or generate the second test image 312B would involve using the charging element 262, writing element 264, developer 266, photoconductor 272, transfer point 278 and fuser 268 of the n^{th} marking engine.

Where marking engines include other marking technologies, other elements actuators are involved. For example, where the plurality of marking engines 208 includes marking engines that are based on ink jet technology, marks are placed on media with an ink jet printhead involving piezoelectric or thermal ink ejection technologies.

The half-tone stripes 312A, 312B may be narrower and/or shorter than as depicted, subject to transmission sensor size, paper placement tolerances, and signal to noise ratio. Since the success of this approach relies only on the measurement of a difference (and not an absolute signal), it is very tolerant of noise factors such as contamination and spacing variations. Although the half-tone stripes 312A, 312B are depicted near the center of the sheet 310, they could be placed anywhere on the sheet 310 and might be embedded in a banner sheet. When two or more marking engines are present, the adjustments can be applied among all possible pairs.

A transmission sensor 316 consisting of a light source (e.g. an emitter) 318 and a light-receiving element (e.g. a detector) 320 which are opposite to each other, is used to measure the test patches 312A, 312B. Although not shown in FIG. 1 or FIG. 2, the transmission sensor (or emitter-detector pair) 316 would be located after fusing and before finishing. As shown in FIG. 6, the emitter 318 and the detector 320 are set up so that the half-tone stripes 312A, 312B are between the emitter 318 and the detector 320 as the sheet 310 progresses along the paper path. A comparison of the average signal received from the first stripe 312A to that received from the second stripe 312B provides a measurement of the difference in half-tone TRC performance between the marking engines. An image quality adjustment of the first marking engine and/or the second marking engine can be based on the measured difference using the methods described below.

The emitter 318, which acts as a light source, illuminates the sheet 310 and the test images 312A, 312B. The detector 320 measures the amount of light directed through respective portions of the test images 312A, 312B. That is, the emitter-detector pair 316 moves over the test image images 312A, 312B as the sheet 310 progresses through the system in the process direction 314. Contone or gray level values associated with the transmitted light measurements of the photosensors can be recorded in association with position information, or the photocurrent can be averaged over a time interval coincident with the passage of each of the test images. The contoned or gray level values may be compared to a threshold and representative binary values may be recorded in association with the position information indicating whether the position is “light” or “dark.” For instance, the measurement information is provided to a test patch analyzer (e.g., 284). If necessary, the test patch analyzer 284 stores the data as described above and then starts the analysis process.

Analyzing 306 the test images 312A, 312B can include any analysis appropriate to test the images and the aspect or aspects of marking engine processes that are being studied, analyzed, adjusted or compensated for. In the Monte Carlo simulations mentioned above, the aspect of the test images that was used to determine xerographic actuator adjustment 308 was lightness. Specifically, relative L*, as defined by the Commission Internationale de l'Eclairages (CIE) was analyzed and compensated for. Thus, in embodiments, a lightness metric, for example, relative L*, is calculated by comparing a background lightness to the lightness of an image or test patch. Contone values or gray levels are determined for a white or unmarked portion of the imaged version of a test image. The test image is a mid-tone test patch having an area A. The test patch is imaged, as is an adjacent unmarked portion of the test images 312A, 312B. Contone or gray level values are measured and recorded for both the test patch and the adjacent unmarked portions. An unmarked portion of the test image also having an area A is selected. Contone or gray scale values associated with pixels or measurements of that area are averaged. Contone or gray level values of the test patch area are also averaged. A ratio of the two averages R=average patch contone value/average unmarked (paper or media) contone value is determined. Based on that ratio (R) relative L* is calculated according to the equation L*=116×R^{1/3}−16.

The analysis 306 continues with a comparison of the determined parameters or parameters associated with the test images to some standard or target parameter value or values and/or with a comparison of the calculated or determined parameters associated with the first test image and the second test image to each other. For example, in addition to the comparison of transmitted light between test images 312A and 312B, the light from each test image can be compared to a target value determined during product development and stored in memory. This target value for transmitted light can also be updated by measuring the printed test sheet 310 using the image input device 212, thereby creating a calibration between the transmitted light measurement and a reflection L* measurement of the same sheet. The results of such comparisons may then be used to calculate or determine an adjustment amount for at least one aspect of marking engine operation, such as, for example, a xerographic actuator, ink jet ejection voltage or power, or to an image path compensation means.

In the Monte Carlo simulations mentioned above, raster output scanner ROS exposure and charging scorotron grid voltage were determined to be effective actuators for controlling or reducing engine response curve variation. However, other actuators or compensation means may be used.

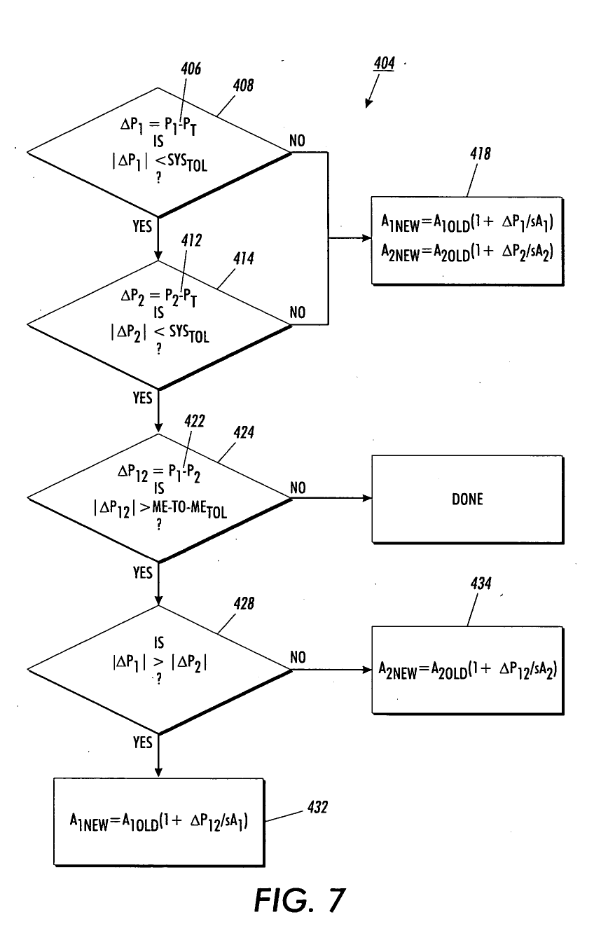

Referring to FIG. 7, one method 404 of analysis 308 includes comparing 406 a first aspect or parameter (P₁) of the first test image 312A to a predetermined aspect or parameter target value (P_{T}), thereby determining a first difference (ΔP₁) between the first aspect or parameter (P₁) of the first test image 312A and the target value (P_{T}) for that aspect or parameter (P). The magnitude of the first difference (ΔP₁) is compared 408 to a system tolerance (SYS_{TOL}) for that parameter or aspect.

Similar processing is carried out with regard to the second test image 312B. A second aspect or parameter (P₂) of the second test image 312B is compared 412 to the aspect or parameter target (P_{T}), thereby determining a second difference (ΔP₂) between the second aspect or parameter (P₂) of the second test image 312B to the target aspect or parameter (P_{T}). The magnitude of the second difference (ΔP₂) is also compared 414 to the system tolerance.

If either the magnitude of the first difference (ΔP₁) or the magnitude of the second difference (ΔP₂) is greater than the system tolerance threshold (SYS_{TOL}), then an adjustment amount is determined 418 based on the first difference (ΔP₁) and the second difference (ΔP₂) respectively. For instance, a new actuator setting (or image path compensation parameter) (Δ_{1 NEW}) for the first printing or marking engine may be a function of the current actuator setting (Δ_{1 OLD}), the first difference (ΔP₁) and a predetermined sensitivity (sA₁) of the first aspect or parameter (P₁) to changes in the actuator setting. Likewise, a new actuator (or image path compensation parameter) setting (A_{2 NEW}) for the second printing or marking engine may be determined 418 as a function of the current actuator setting (A_{2 OLD}), the second difference (ΔP₂) and a predetermined sensitivity (sA₂) of the second aspect or parameter (P₂) to changes in the second actuator setting.

In the embodiment illustrated in FIG. 7, the functions are selected so that the determined 418 new actuator settings (A_{1 NEW}), (A_{2 NEW}) tend to drive the first parameter (P₁) of the first marking engine and the second parameter (P₂) of the second marking engine toward the target parameter (P_{T}) and therefore, toward each other. Additionally, if either the first difference (ΔP₁) or the second difference (ΔP₂) is determined 406, 412 to be zero, the functions of the illustrated embodiment provide for determining 418 new actuator settings to be the same as the current actuator settings. Since, the new actuator settings tend to drive the aspects or parameters (P₁), (P₂) of the first and second marking engines (e.g., 108, 110 or 214, 216 or 218) toward the target parameter (P_{T}) and therefore, toward each other, they improve, or achieve, image consistency from print to print within each engine individually, and between prints rendered or printed with different marking engines (e.g., 108, 110 or 214, 216 or 218).

It may also be desirable to drive the first parameter (P₁) of the first print engine and the second parameter (P₂) of the second print engine toward one another even when both aspects or parameters (P₁), (P₂) are within the system tolerance (e.g., SYS_{TOL}) of the target parameter value (P_{T}). Therefore, if the determination 408 is made that the magnitude of the first difference is less than the system tolerance threshold for the target parameter (P_{T}), and the determination 414 is made that the magnitude of the second difference (ΔP₂) is less than the system tolerance threshold for the target parameter value (P_{T}), then the first aspect or parameter value (P₁) can be compared 422 to the second aspect or parameter value (P₂), thereby determining a first marking engine to second marking engine variation or difference (ΔP₁₂). At that point, a determination 424 can be made as to whether the magnitude of the marking engine to marking engine difference (ΔP₁₂) is greater than a marking engine to marking engine tolerance threshold (ME-to-ME_{TOL}).

If it is determined 424 that the marking engine to marking engine variation or difference (ΔP₁₂) is greater than the marking engine to marking engine tolerance (ME-to-ME_{TOL}), a determination 428 is made as to which of the magnitude of the first difference (ΔP₁) and the magnitude of the second difference (ΔP₂) is larger. If the magnitude of the first difference (ΔP₁) is larger, then a determination 432 of a new actuator setting (A_{1 NEW}) for the first marking engine (e.g., 108, 214) may be made from a function of the current actuator setting (A_{1 OLD}), the marking engine to marking engine variation or difference (ΔP₁₂) and the predetermined sensitivity (sA₁) of the first parameter (P₁) to changes in the first actuator setting (A₁). Likewise, if it is determined 428 that the magnitude of the second difference (ΔP₂) is larger than the magnitude of the first difference (ΔP₁), then a new second actuator setting (A_{2 NEW}) may be determined 434 from a function of the current second actuator setting (A_{2 OLD}), the marking engine to marking engine variation or difference (ΔP₁₂) and the sensitivity (sA₂) of the second parameter or aspect (P₂) to changes in the second actuator setting.

In the illustrated embodiment of FIG. 7, the selected functions for determining 432, 434 new values for the first actuator setting (A₁) and the second actuator setting (A₂) tend to drive the aspect of the affected marking engine toward the same value as the similar aspect of the other marking engine.

As indicated above, in the Monte Carlo simulations, the aspect or parameter (P) that was measured and controlled was L*. The actuator (A) that was adjusted 338 was ROS exposure. However, it is anticipated that charging scorotron grid voltage can also be used to control or adjust marking engine L*. Furthermore, other aspects or parameters of rendering device performance may also be controlled or compensated for according to the methods outlined in FIGS. 3 and 7.

For example, test images might be used for measuring gloss, registration and Euclidean color distance (e.g., ΔE). Such targets may be printed (e.g., 302, 304), and test patch analyzers 284 might be used to analyze 306 the test images and determine new settings for actuators or image path adjustments for use by an actuator adjuster 288. For instance, gloss may be controlled by adjusting fuser (e.g., 228, 248, 268) temperature, registration may be controlled by adjusting 308 ROS alignment or timing, or by applying compensating warpings in the image path. Color (e.g., ΔE) may be corrected or controlled by adjusting exposure or ROS power levels. Alternatively, the shape and position of compensating tone reproduction curves (TRCs), which operate on image data, may be adjusted 308. Furthermore, more than one actuator may be used to correct a particular aspect or parameter of marking engine operation.

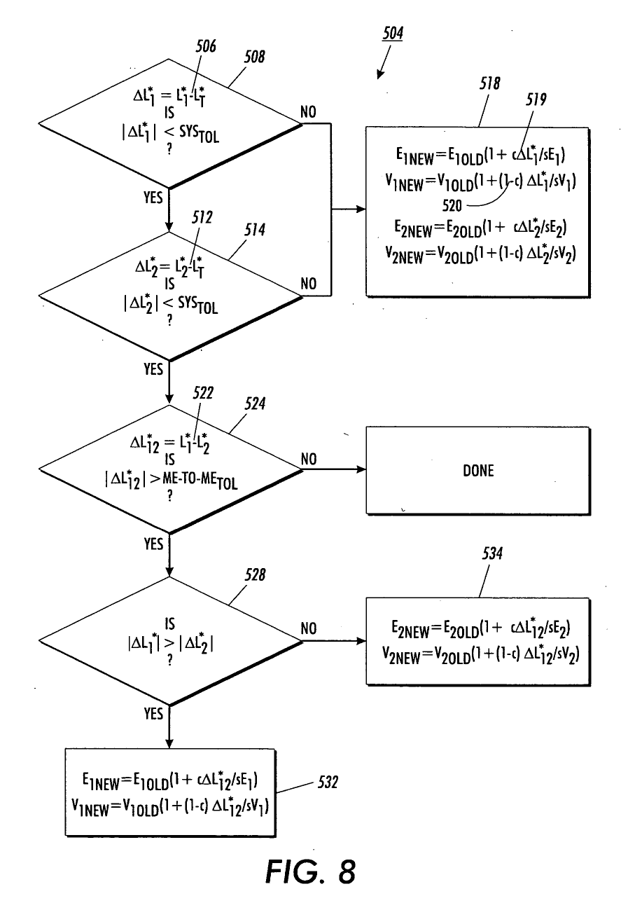

FIG. 8 illustrates a second method 504 of analysis 306, which is similar to the first method 404. However, in the second method 504, a specific parameter (P) has been selected for analysis and control. The aspect or parameter of marking engine performance selected is lightness (L*). Therefore, a first lightness (L₁*) is calculated based on a first test image 312A printed with a first marking engine and compared 506 with a target lightness (L_{T}*), thereby determining a first lightness difference (ΔL₁*). The magnitude of the first lightness difference (ΔL₁*) is compared 508 to a system tolerance threshold. Similarly, a second lightness (L₂*) is calculated from a second test image 312B printed with a second marking engine. The second lightness (L₂*) is compared 512 to the target lightness (L_{T}*), thereby generating, calculating or determining, a second difference (ΔL₂*). If the magnitude of either the first difference (ΔL₁*) or the second difference (ΔL₂*) is greater than the system tolerance threshold, new actuator settings are determined 518 for actuators associated with both the first and second marking engines (e.g., 108, 110, 214, 216 or 218).

However, in contrast to the determination 418 made in the first 404 method of analysis, the determination 518 of the second method 504 of analysis 306 includes determining new settings for more than one actuator for each marking engine. New settings are determined 518 for a ROS exposure actuator (E) and for a scorotron grid voltage (V) for each marking engine. The new exposure for the first marking engine (E_{1 NEW}) is a function of the current exposure setting for the first marking engine (E_{1 OLD}), the first lightness difference (ΔL₁*), a predetermined sensitivity (sE₁) of the lightness (L₁*) of the first marking engine to changes in exposure (E₁), and an apportioning constant c.

The apportioning constant c is applied to a term 519 including the first difference (ΔL₁*) and the sensitivity (sE₁) of the first lightness (L₁*) to changes in ROS exposure (E₁).

The new grid voltage (V_{1 NEW}) of a first scorotron of the first marking engine is determined 518 based on a function of the current first scorotron grid voltage (V_{1 OLD}), the first lightness difference (ΔL₁*) and a sensitivity (sV₁) of the first lightness (L₁*) to changes in the first grid voltage (V₁) and an apportioning factor 520 having a value of one minus the apportioning constant (c) (i.e.; 1-c). The apportioning factor 520 is applied to a term 521 including the first lightness difference (ΔL₁*) and the sensitivity (sV₁) of the first lightness (L₁) to changes in the first scorotron grid voltage (V₁). The apportioning constant may be restricted to a value between 0 and 1 inclusive. When the apportioning constant (c) has a value of 1, the apportioning factor 520 has a value of 0 and the new grid voltage (V_{1 NEW}) for the first scorotron is equal to the current grid voltage (V_{1 OLD}) and only the ROS exposure (E₁) is used to control the lightness (L₁*) in the first marking engine. When the apportioning constant (c) has a value of 0, the converse is true. The new ROS exposure setting (E_{1 NEW}) is set equal to the current ROS exposure (E_{1 OLD}) and only the first scorotron grid voltage ((V₁) is used to control or adjust lightness (L*₁) in the first marking engine. When the apportioning constant (c) has an intermediate value, both the ROS exposure (E₁) and the scorotron grid voltage (V₁) are updated to contribute to the control of lightness (L*₁) in the first marking engine.

As can be seen in FIG. 8, new settings for ROS exposure and scorotron grid voltage in the second marking engine are determined 518 from functions having a similar form to the functions discussed above with reference to the first marking engine. However, the functions are based on the second lightness difference (ΔL₂*), sensitivities (sE₂, sV₂) of the second lightness (L₂) of the second marking engine to changes in ROS exposure (E₂) and scorotron grid voltage (V₂) and current ROS exposure (E_{2 OLD}) and scorotron grid voltage (V_{2 OLD}) in the second marking engine, instead of the similar parameters relating to the first marking engine.

As was the case in reference to FIG. 7, the determinations 518 tend to drive the lightness parameters of the first and second marking engines toward the lightness target value (L*_{T}), and thereby within the system tolerance (SYS_{TOL}) and toward each other. This has the effect of improving image consistency over time within a single marking engine and between marking engines. However, it may also be desirable to drive the lightness parameters of marking engines in an image or document processing system toward one another even when the marking engines are all operating within a system tolerance (e.g., SYS_{TOL}). Therefore, when both the first lightness difference (ΔL₁*) and the second lightness difference (ΔL₂*) have magnitudes that are less than the system lightness tolerance (SYS_{TOL}) the first lightness (L₁*) is compared to the second lightness (L₂*), thereby determining a third lightness difference (ΔL₁₂*) between the first marking engine and the second marking engine.

If the third lightness difference (ΔL₁₂*) between the marking engines is greater than a marking engine to marking engine lightness tolerance (ME-to-ME_{TOL}) then the magnitude of the first lightness difference (ΔL₁*) is compared to the magnitude of the second lightness difference (ΔL₂*) and new actuator settings are determined for the marking engine associated with the largest difference magnitude (532 or 534). The functions by which the new settings are determined are similar in form to the functions described in reference to the determination 518 associated with at least one of one of the first and second differences (ΔL₁* or ΔL₂*) being greater than the system lightness tolerance. However, instead of being based on the respective lightness differences (ΔL₁* or ΔL₂*) the determinations 532, 534 are made based on the third lightness difference (ΔL₁₂*) between the first and second marking engines. The new determined (532 or 534) marking engine actuator settings will drive the lightness of the affected marking engine toward the lightness of the other marking engine. Therefore, the second method 504 of analyzing 333 the scanned, generated or imaged (326, 330) versions of the printed or rendered (318, 322) test image is operative to control or maintain marking engine to marking engine consistency.

Advantages of the methods and systems disclosed herein include the ability to be implemented as a runtime option, which would extend the interval between (offline) scanner-based image quality adjustments, an increased sensitivity of transmission over reflection measurements, and the elimination of errors caused by substrate variability.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
printing a first test image on one side of print media with a first marking engine in an image rendering system;
printing a second test image on the opposite side of the print media with a second marking engine in the image rendering system;
determining image consistency information from the test images; and, optionally,
adjusting at least one aspect of the image rendering system to improve image consistency.

2. The method of claim 1 wherein determining image consistency information from the test images comprises:
illuminating the print media with a light source; and
measuring the amount of light directed through respective portions of the test images with a detector.

3. The method of claim 1 further comprising:
comparing an aspect of the first and second test images to a predetermined aspect target, thereby determining a difference between the aspect of the first test image and the aspect of the second test image to the aspect of the target; and
comparing the difference between the aspect of the first test image and the target to the difference between the aspect of the second test image and the target.

4. The method of claim 1 wherein determining image consistency information from the test images comprises:
comparing an aspect of the first test image and a similar aspect of the second test image to each other, thereby determining a difference between the aspect of the first test image and the aspect of the second test image.

5. The method of claim 1 wherein determining image consistency information from the test images comprises:
determining image lightness information from the first and second test images by determining a ratio of gray scale values associated with a marked portion of the test images and gray scale values associated with an unmarked portion of the test images for each of the first and second test images.

6. The method of claim 1 wherein adjusting at least one aspect of the image rendering system comprises:
adjusting a marking engine actuator of at least one of the marking engines.

7. The method of claim 6 wherein adjusting the marking engine actuator of at least one of the marking engines comprises at least one of adjusting a raster output scanner exposure set point, adjusting a scorotron grid voltage set point, and adjusting an ink jet drop ejection voltage.

8. The method of claim 6 wherein adjusting at least one marking engine actuator of at least one of the marking engines comprises:
adjusting an ROS exposure and a charging element voltage.

9. An image quality control method for a xerographic print system having a plurality of marking engines, the method comprising:
printing a first test image on one side of print media with a first marking engine;
printing a second test image on the other side of the print media with a second marking engine;
determining image consistency information from the test images; and, optionally,
adjusting at least one aspect of the xerographic print system, in a manner predetermined to improve image consistency, based on the determined image consistency information.

10. The method of claim 9 wherein determining image consistency information from the test images comprises:
illuminating the print media with a light source; and
measuring the amount of light directed through respective portions of the test images with a detector.

11. The method of claim 10 wherein determining image consistency information from the test images comprises:
determining a first lightness metric for at least a portion of the first test image;
determining a second lightness metric for at least a portion of the second test image;
comparing the first lightness metric to a target lightness associated with the test images, thereby determining a first difference between the first lightness metric and the target lightness; and,
comparing the second lightness metric to the target lightness, thereby determining a second difference between the second lightness metric and the target lightness.

12. The method of claim 11 further comprising:
comparing a magnitude of the first difference to a magnitude of the second difference, thereby determining a larger of the first difference and the second difference magnitude, if both of the first difference and the second difference have magnitudes less than a predetermined acceptable magnitude; and
adjusting at least one xerographic actuator of the xerographic print engine associated with the larger of the first difference magnitude or the second difference magnitude.

13. The method of claim 12 further comprising:
adjusting at least one xerographic actuator of each of the first xerographic print engine and the second xerographic print engine if the magnitude of at least one of the first difference and the second difference is greater than the predetermined acceptable magnitude.

14. The method of claim 13 wherein adjusting at least one xerographic actuator comprises at least one of adjusting a raster output scanner power, adjusting a scorotron grid voltage, or adjusting a raster output scanner exposure.

15. The method of claim 14 wherein each of the test images is intended to have an area coverage of about 50%.

16. A document processing system comprising:
a plurality of xerographic print engines, each xerographic print engine having at least one xerographic actuator;
a test patch generator operative to control each of the plurality of xerographic print engines to generate a mid-tone test patch on both sides of a sheet;
an emitter positioned to emit light through the sheet;
a detector positioned to detect the light emitted by the emitter;
a test patch analyzer operative to analyze a plurality of test patches generated by the plurality of xerographic print engines, and operative to determine an amount at least one of the xerographic actuators should be adjusted based on the analysis; and
a xerographic actuator adjuster operative to adjust the at least one xerographic actuator according to the amount determined by the test patch analyzer.

17. The document processing system of claim 16 wherein the emitter and the detector are set up so that the mid-tone test patches are between the emitter and the detector as the sheet progresses along the paper path of the document processing system.

18. The document processing system of claim 16 wherein the test patch analyzer is operative to determine an amount at least one xerographic actuator should be adjusted by analyzing a first computer readable version of at least a portion of a first test patch associated with a first xerographic print engine to determine a first lightness metric, analyzing a second computer readable version of at least a portion of a second test patch associated with a second xerographic print engine to determine a second lightness metric, comparing the first lightness metric to a target lightness associated with the predetermined test image, thereby determining a first difference between the first lightness metric and the target lightness, comparing the second lightness metric to the target lightness, thereby determining a second difference between the second lightness metric and the target lightness, and comparing a magnitude of the first difference and a magnitude of the second difference to a predetermined acceptable magnitude, and to adjust at least one xerographic actuator associated with the first xerographic print engine according to the magnitude of the first difference, and to adjust at least one xerographic actuator associated with the second xerographic print engine according to the magnitude of the second difference if at least one of the first difference magnitude and the second difference magnitude is above the predetermined acceptable difference magnitude, and to adjust at least one xerographic actuator associated with the larger of the first difference magnitude and the second difference magnitude if both the magnitude of the first difference and the magnitude of the second difference is less than that the predetermined acceptable difference magnitude.

19. The document processing system of claim 16 wherein the test patch analyzer is operative to determine an amount at least one xerographic actuator should be adjusted by analyzing a first computer readable version of at least a portion of a first test patch associated with a first xerographic print engine to determine a first lightness metric, analyzing a second computer readable version of at least a portion of a second test patch associated with a second xerographic print engine to determine a second lightness metric, comparing the first lightness metric to a target lightness associated with the predetermined test image, thereby determining a first difference between the first lightness metric and the target lightness, comparing the second lightness metric to the target lightness, thereby determining a second difference between the second lightness metric and the target lightness, and comparing a magnitude of the first difference and a magnitude of the second difference to a first predetermined acceptable magnitude, and to adjust at least one xerographic actuator associated with the first xerographic print engine according to the magnitude of the first difference, and to adjust at least one xerographic actuator associated with the second xerographic print engine according to the magnitude of the second difference if at least one of the first difference and the second difference is above the first predetermined acceptable difference magnitude, and to determine a magnitude of a third difference between the first difference and the second difference and adjust at least one xerographic actuator associated with the larger of the magnitude of the first difference and the magnitude of the second difference if both the magnitude of the first difference and the magnitude of the second difference are less than that the first predetermined acceptable difference magnitude and the third difference magnitude is greater than a second predetermined acceptable magnitude.

20. The document processing system of claim 16 wherein the xerographic actuator adjuster is operative to adjust raster output scanner exposure and charge grid voltage of at least one xerographic print engine.
